(19) United States
(12) Patent Application Publication
(10) Pub. No.: US 2014/0246321 A1
(43) Pub. Date: Sep. 4, 2014

(54) PARTICLE SEPARATION DEVICE AND METHOD

(71) Applicants: Nobuhiro Tsukada, Tokyo (JP); Kei Takenaka, Tokyo (JP)

(72) Inventors: Nobuhiro Tsukada, Tokyo (JP); Kei Takenaka, Tokyo (JP)

(73) Assignee: HITACHI, LTD., Tokyo (JP)

(21) Appl. No.: 14/353,057

(22) PCT Filed: Nov. 9, 2011
(86) PCT No.: PCT/JP2011/075872

§ 371 Date: Apr. 21, 2014

(51) Int. Cl. B03C 5/00

(52) U.S. Cl. CPC B03C 5/005
USPC 204/601

(57) ABSTRACT

Micropillars are arranged a first row up to an nth row, the micropillars in one row are disposed at the same interval “a” from each other, and each of the rows is disposed in a position shifted by a distance “b” with respect to an immediately preceding upstream row, in a row direction. A liquid that contains particles flows through between the micropillars. A voltage is applied from a power supply to electrodes, thereby generating an electric field in a flow channel. The micropillars are electrical insulating structures, so in regions of narrow intervals between the micropillars, electrical lines of force are dense and strength of the electric field is high, and in regions of wide intervals between the micropillars, electrical lines of force are sparse and the strength of the electric field is low.

### TECHNICAL FIELD

The present invention relates to a particle separation device and method for separating particles from a liquid.

### BACKGROUND ART

A general method for removing particles from a liquid containing particles, such as industrial water, is adopted as a treatment using a separation membrane.

For example, particles suspended in a liquid can be filtered out by using a microfiltration membrane of several micrometers in pore size to remove particles of several micrometers in size from the liquid containing the particles. During the filtration, the separation membrane gradually becomes clogged with the particles and increase in permeation resistance. To maintain a constant flow rate of the liquid which passes through the separation membrane, therefore, a pressure for supplying the liquid needs to be increased.

This means that there is a need to periodically clean the separation membrane and remove the particles that clogs the membrane. Patent Document 1, for example, discloses a method for supplying acid water to a permeation water side of a membrane filtration device, next supplying the liquid to a separation membrane in a direction reverse to a normal direction, and thereby removing the particles clogging the separation membrane.

In addition, Patent Document 2 discloses a method intended to separate an analyte from a biological sample by using dielectrophoretic force, a force exerted upon dielectrics such as droplets and molecules as well as particles contained in the liquid, by application of a nonuniform electric field, and thus separating two and more kinds of molecules from the liquid.

Applying a voltage to two striped electrodes formed on a lower surface of a microflow channel so as to face each other develops an electric field between the electrodes. The electric field developed at this time will be of a nonuniform strength level at which the electric field maintains high strength in a neighborhood of the electrodes and the field strength decreases with increasing distance from the electrodes. In this case, the dielectrophoretic force by which the molecules contained in the liquid are attracted from regions of lower field strength, toward regions of higher field strength, will be exerted upon the molecules.

As a result, while being attracted to the neighborhood of the electrodes, the molecules in the liquid will move downstream by reason of a fluid drag caused by a flow of the liquid. Magnitude of the dielectrophoretic force will differ according to dielectric constants of the dielectrics. Therefore, two kinds of liquid-suspended molecules having different dielectric constant will migrate at different speeds due to a difference in the dielectrophoretic force. Thus, the molecules will be separated in the direction that the liquid flows.

Non-Patent Document 1 discloses a method for separating particles in a microflow channel according to size. A plurality of micropillars each having substantially the same cross-sectional area as that of each particle are formed inside the microflow channel. The micropillars are arranged in rows at equal intervals in a direction perpendicular to that in which a liquid containing the particles flows. Each of the rows is disposed in a position shifted by a fixed distance, in the direction perpendicular to the flow direction, with respect to an immediately preceding upstream row. At this time, since small particles can pass through between the micropillars, these particles move with the liquid in a direction parallel to the flow channel irrespective of the layout of the micropillars.

Large particles, on the other hand, cannot pass through between the micropillars, these particles move obliquely relative to the flow of the liquid according to the particular shift in position of the micropillars. Consequently, the plurality of particles of different sizes that have existed at the same upstream position in the flow channel will take up different downstream positions in the flow channel.

Moreover, Non-Patent Document 2 discloses a method for removing boron from a boron-containing solution by use of particles that adsorb boron. In this method, after the particles that adsorb boron have been dispersed in the solution and the boron contained therein has been adsorbed, the solution is filtered using a separation membrane, whereby the particles are removed and a boron-free liquid is obtained.

### PRIOR ART DOCUMENTS

### Patent Documents

Patent Document 1: JP No. 4304803
Patent Document 2: JP-2001-165906-A

### Non-Patent Documents

Non-Patent Document 1: Science, Vol. 304 (2004), pp. 987-990
Non-Patent Document 2: Desalination, Vol. 241 (2009), pp. 127-132

### SUMMARY OF THE INVENTION

### Problems to be Solved by the Invention

However, in a method for removing particles from a liquid by use of a separation membrane, as in the related art outlined above, a device that supplies another liquid to clean the separation membrane is needed in addition to the device that supplies a liquid for normal filtration, so a total device scale tends to become very large. It is also difficult to completely remove the particles clogging the separation membrane, even by cleaning the membrane. For this reason, there is a need to replace the separation membrane after use for a certain period of time, and thus the separation membrane has difficulty in extending service life.

In such a case, application of the technique disclosed in Patent Document 2 enables the removal of the particles from the liquid without using a separation membrane. This means that only the liquid can be extracted from a downstream region of the flow channel by generating a dielectrophoretic force large enough to prevent the particles from moving by reason of the fluid drag, and capturing and confining these particles in a neighborhood of electrodes.

Since it is unnecessary in this method to use a separation membrane, the clogging of the particles does not occur and no separation membrane cleaning is needed.

Continued capture and confinement of the particles in the flow channel by means of the dielectrophoretic force, however, may block the flow channel. To avoid this, therefore, it is necessary to periodically stop the generation of the dielectrophoretic force and allow the captured and confined particles to flow in a downstream direction. This poses a problem that throughput cannot be increased because of continuous water treatment being unable to be performed.

In addition, it is conceivable that the method disclosed in Non-Patent Document 1, that is, deflecting the particles by the use of the micropillars would be applied to removing the particles from the liquid. A pressure loss in the flow channel may result from such application.

More specifically, as the particles to be separated decrease in size, the intervals between the pillars need to be narrowed, which, if done, will lead to increased pressure loss in the flow channel. Liquid leakage will result if the pressure loss in the flow channel increases above a pressure-withstanding capability of the device, so the pressure loss in the flow channel needs to be reduced below the pressure-withstanding capability.

Since the pressure loss in the flow channel varies directly as a flow rate of the liquid flowing through the flow channel, throughput cannot be increased if the pressure loss in the flow channel is reduced below the pressure-withstanding capability.

An object of the present invention is to provide a particle separation device and method contemplated so as to require no membrane cleaning, and yet so as to cause no clogging, extend device life, reduce a pressure loss, and enable increasing throughput capacity and downsizing the device.

### Means for Solving the Problems

The present invention is properly configured to achieve the above object.

That is to say, the invention is configured to: draw in a suspension containing a plurality of dielectric particles suspended therein; pass the suspension through between a plurality of micropillars each formed from an electrical insulating material and disposed in the flow channel to which the particle suspension that has been drawn in is supplied and into which the particle suspension flows; generate an electric field in the flow channel having the micropillars disposed therein; cause the micropillars to form electrically sparse and dense regions of the electric field and thus to deflect the particles in a definite direction in the suspension and separate the particles from the suspension; draw out a particle concentrated liquid containing the concentrated particles that have been separated from the suspension, into a particle concentrated liquid outflow channel; and draw out a particle-free liquid, in which the particles have been removed from the suspension, into a particle-free liquid outflow channel.

### Effects of the Invention

With the above configuration, the particle separation device and method contemplated so as to require no membrane cleaning, and yet so as to cause no clogging, extend device life, reduce a pressure loss, and enable increasing throughput capacity and downsizing the device, can be provided.

### BRIEF DESCRIPTION OF THE DRAWINGS

FIG. 1 is a schematic block diagram of a particle separation device which is an embodiment of the present invention;

FIG. 2 is a diagram that shows construction of a particle separation unit formed on a flow channel substrate of the particle separation device shown in FIG. 1;

FIG. 3 is a top view of a particle separating section in the embodiment of the present invention;

FIG. 4 is an explanatory diagram that shows the way the particle separation device operates in the embodiment of the present invention;

FIG. 5 is a diagram that shows time-varying changes in the voltage applied to the electrodes 2501, 2502.

FIG. 6 is a diagram showing an example of a shape and layout of electrodes in a microflow channel of the particle separation device in the embodiment of the present invention;

FIG. 7 is a diagram showing another example of a shape and layout of electrodes in the microflow channel of the particle separation device in the embodiment of the present invention;

FIG. 8 is a diagram showing yet another example of a shape and layout of electrodes in the microflow channel of the particle separation device in the embodiment of the present invention;

FIG. 9 is a diagram showing an example of a shape of micropillars of the particle separation device in the embodiment of the present invention;

FIG. 10 is a diagram showing another example of a shape of micropillars of the particle separation device in the embodiment of the present invention;

FIG. 11 is a diagram showing yet another example of a shape of micropillars of the particle separation device in the embodiment of the present invention;

FIG. 12 is a diagram showing still another example of a shape of micropillars of the particle separation device in the embodiment of the present invention;

FIG. 13 is a diagram showing a further example of a shape of micropillars of the particle separation device in the embodiment of the present invention;

FIG. 14 is a diagram showing a further example of a shape of micropillars of the particle separation device in the embodiment of the present invention;

FIG. 15 is a diagram showing an example in which the particle separation device in the embodiment of the present invention is constructed for treating a large amount of liquid;

FIG. 16 is a diagram showing another example in which the particle separation device in the embodiment of the present invention is constructed for treating a large amount of liquid;

FIG. 17 is an overall schematic block diagram of a boron removal device in the embodiment of the present invention; and

FIG. 18 is a diagram that shows construction of a boron removal unit formed on a flow channel substrate of the boron removal device shown in FIG. 17.

### MODES FOR CARRYING OUT THE INVENTION

Hereunder, an embodiment of a particle separation device and method according to the present invention will be described.

### Embodiment

FIG. 1 is a schematic block diagram of a particle separation device to which the present invention is applied. Referring to FIG. 1, the particle separation device includes the following: a flow channel device 3 with a flow channel substrate 1 and a covering substrate 2; line connectors 501, 502, and 503 that connect the flow channel device 3 and lines 401, 402, and 403; a pump 7 that supplies a particle suspension 6 to the flow channel device 3; a particle suspension container 8 accommodating the particle suspension 6; and a particle-free liquid container 10 accommodating a particle-free liquid 9 that flows out from the flow channel device 3.

The particle separation device further includes the following: a particle concentrated liquid container 12 accommodating a particle concentrated liquid 11 that flows out from the flow channel device 3; electrode connectors 1301 and 1302 that electrically connect to electrodes disposed inside the flow channel device 3; a power supply 14 that supplies a voltage to be applied to the electrode connectors 1301, 1302; a controller 15 that controls the voltage to be applied to the electrode connectors 1301, 1302; and an electrical line 16 that electrically connects the electrode connectors 1301, 1302, the power supply 14, and the controller 15, to each other.

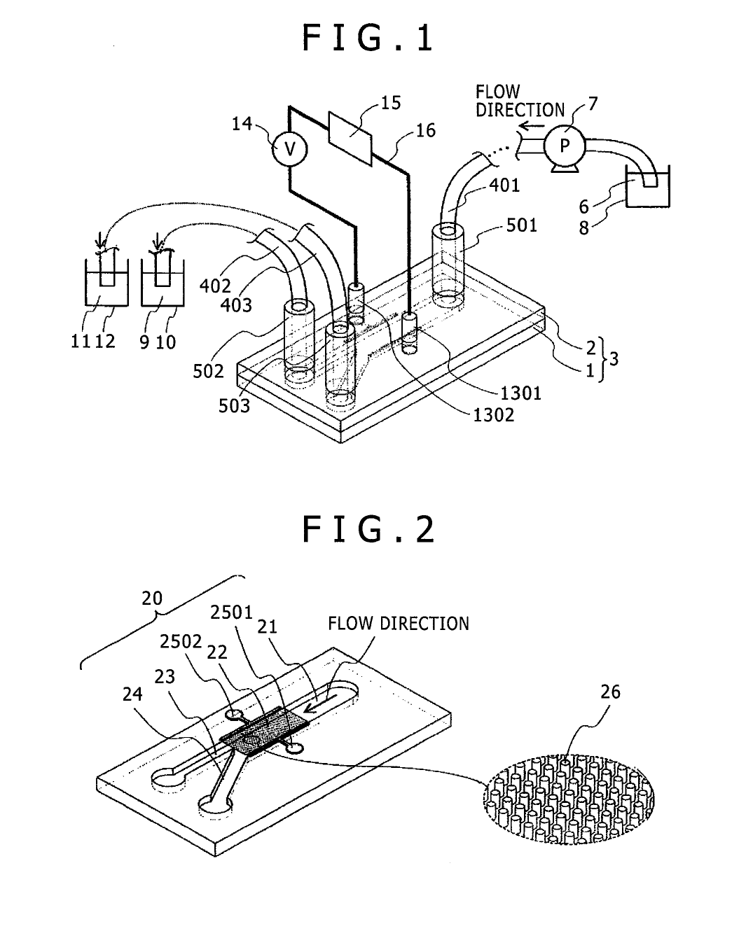

FIG. 2 is a diagram that shows construction of a particle separation unit 20 formed on the flow channel substrate 1 of the particle separation device shown in FIG. 1.

Referring to FIG. 2, the particle separation unit 20 includes a particle suspension inflow channel 21, a particle separating section 22, a particle-free liquid outflow channel 23, a particle concentrated liquid outflow channel 24, and the electrodes 2501, 2502. A plurality of micropillars 26 are formed on the particle separating section 22.

An example of fabricating the flow channel device 3 shown in FIG. 1 is by fabricating the flow channel substrate 1 from silicon and the covering substrate 2 from a glass material, and then joining both substrates by anodic bonding. In this case, the particle suspension inflow channel 21, the particle separating section 22, the particle-free liquid outflow channel 23, and the particle concentrated liquid outflow channel 24 are formed on the flow channel substrate 1 by deep trench etching of silicon.

In addition, the electrodes 2501, 2502 are formed by covering a silicon surface with an insulating film such as an oxide film or nitride film, and after depositing gold, platinum, aluminum, titanium, or any other appropriate metallic material, forming patterns by photolithography.

Another example of fabricating the flow channel device 3 is by fabricating the flow channel substrate 1 from polydimethylsiloxane and the covering substrate 2 from a glass material, and after plasma irradiation of a surface of the flow channel substrate 1 formed from polydimethylsiloxane, bonding the flow channel substrate 1 and the covering substrate 2 together. In this case, a casting mold of the particle suspension inflow channel 21, particle separating section 22, particle-free liquid outflow channel 23, and particle concentrated liquid outflow channel 24 obtained by deep trench etching of silicon, is transferred to the polydimethylsiloxane to form the flow channel substrate 1.

Yet another example of fabricating the flow channel device 3 is by fabricating both the flow channel substrate 1 and the covering substrate 2 from polydimethylsiloxane, and after plasma irradiation of upper surfaces of the flow channel substrate 1 and the covering substrate 2, bonding both substrates together. In this case, a casting mold of the particle suspension inflow channel 21, particle separating section 22, particle-free liquid outflow channel 23, and particle concentrated liquid outflow channel 24 obtained by deep trench etching of silicon, is transferred to the polydimethylsiloxane to form the flow channel substrate 1.

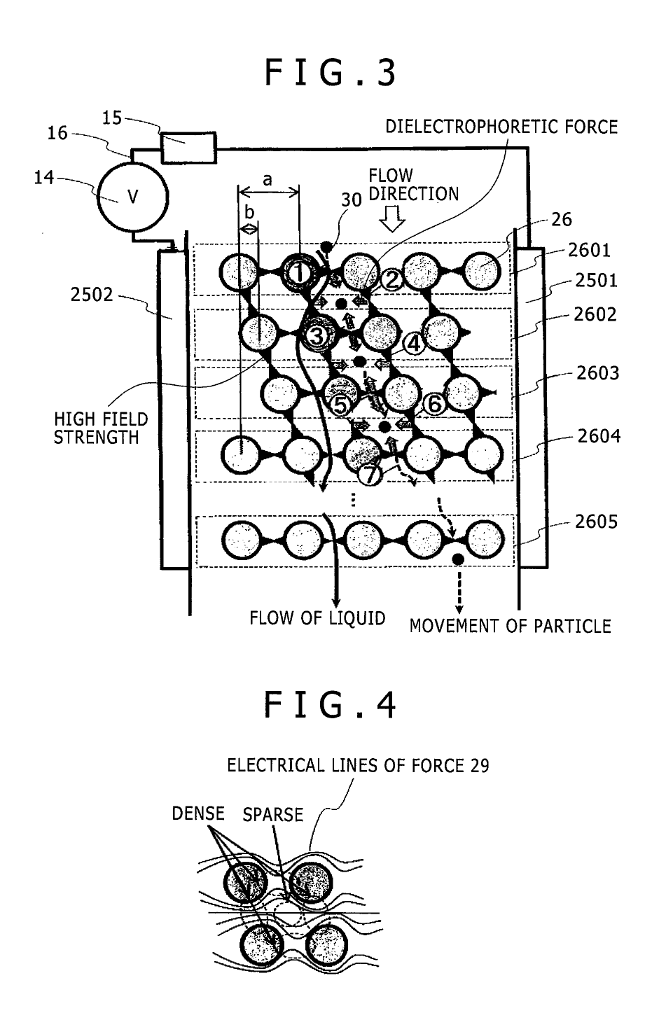

Next, principles of the particle separation by the particle separation device, the embodiment of the present invention, are described below referring to FIGS. 3 to 5.

FIG. 3 is a top view of the particle separating section 22. Referring to FIG. 3, the micropillars 26 are arranged in rows, which are formed by a first row 2601, a second row 2602, a third row 2603, a fourth row 2604, etc., up to an nth row 2605.

For example, the micropillars 26 in one row are disposed at the same interval “a” from each other, and each of the rows is disposed in a position shifted by a distance “b” with respect to an immediately preceding upstream row, in a row direction (substantially perpendicular to a direction in which a fluid flows).

In the example of FIG. 3, b=a/3 holds. This means that positions of the micropillars 26 in every three rows are the same in the row direction (e.g., the micropillars 26 in the first row 2601 and the fourth row 2604 are disposed at the same positions as those of each other in the row direction).

Since a liquid flows through between the micropillars 26, the liquid on a whole flows in a direction parallel to a wall surface forming the flow channel.

The micropillars 26 have a diameter ranging between several micrometers and tens of micrometers, for example. The interval “a” between the micropillars 26 is also between several micrometers and tens of micrometers.

An electric field is generated in the flow channel by application of a voltage from the power supply 14 to the electrodes 2501, 2502. Since the micropillars 26 are formed from an insulating material, electrical lines of force 29 are distributed at positions free of the micropillars 26, as shown in FIG. 4. Therefore, in regions that are narrow in the interval between the micropillars 26, the electrical lines of force 29 are dense and strength of the electric field is high, and in regions that are wide in the interval between the micropillars 26, the electrical lines of force 29 are sparse and the strength of the electric field is low. Briefly, an electric field that is nonuniform in strength is formed. In other words, as shown in FIG. 4, a central portion surrounded by four micropillars 26 have the electrical lines of force 29 that are sparser than those of other portions surrounding the particular central portion, and thus decreases in the strength of the electric field.

In this case, particles 30, which are dielectric substances, undergo dielectrophoretic force (negative dielectrophoresis) that acts to attract the particles 30 from regions of higher electric-field strength to regions of lower electric-field strength. The particles 30 also undergo a fluid drag in the direction that the liquid flows.

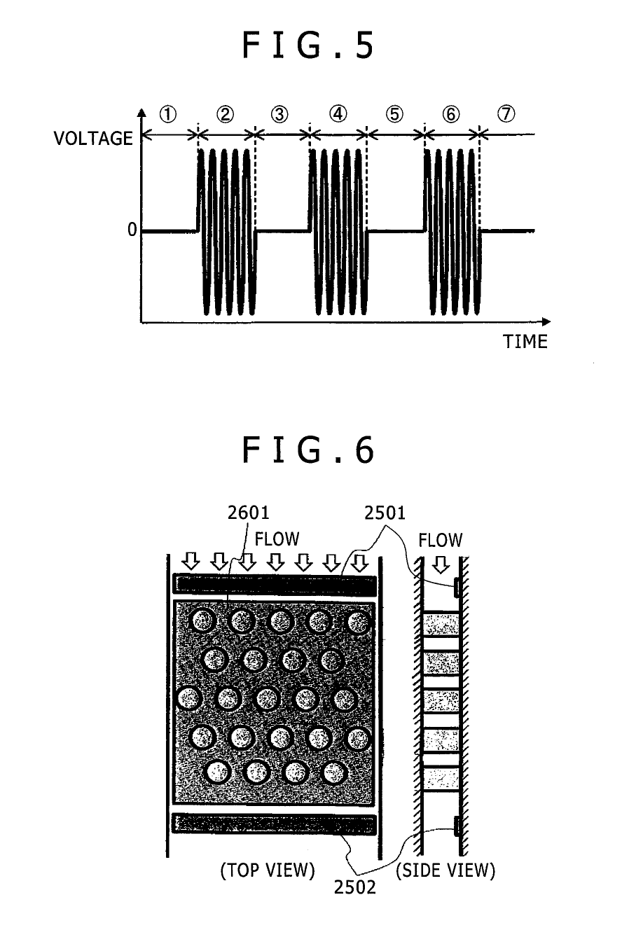

FIG. 5 is a diagram that shows time-varying changes in the voltage applied to the electrodes 2501, 2502. As shown in FIG. 5, when a level of the voltage to be applied is changed at fixed time intervals, the dielectrophoretic force also changes according to the voltage level.

When the voltage to be applied to the electrodes 2501, 2502 is adjusted to become zero during time intervals marked with circles 1, 3, 5, 7 in FIG. 5, the dielectrophoretic force also becomes zero, only the fluid drag works upon the particles 30 and causes one of the particles 30 to move past between the micropillars 26 in the same row. This state is shown with circle 1 in FIG. 3.

After that, when the voltage is applied to the electrodes 2501, 2502 during time intervals marked with circles 2, 4, 6 in FIG. 5, the dielectrophoretic force causes each particle 30 to be captured at the central portion of four micropillars 26 that is a region of low electric-field strength. This state is shown with circles 2, 4, 6 in FIG. 3. Repetition of these operations, that is, the particle capture time intervals (marked with circles 2, 4, 6 in FIG. 5) and the particle movement time intervals (marked with circles 1, 3, 5, 7 in FIG. 5), intermittently applies the voltage to the flow channel to move the particles 30 more effectively along an arrow of a dotted line shown in FIG. 3 (i.e., along the dotted line shown along circles 1, 3, 5, 7) and deflect the particles 30 with respect to the flow of the liquid. In the depicted example, a flow of the particles 30 is deflected in a rightward direction, then converged, and directed toward the particle concentrated liquid outflow channel 24 shown in FIG. 2.

The liquid used is pure water, for example. In addition, polystyrene is used as an example of particles 30. The voltage frequency during the intervals shown with circles 2, 4, 6 in FIG. 5 is a frequency at which the particles 30 are attracted to the regions having sparse electrical lines of force 29 and the frequency is 1 MHz, for example. An operator or the like can change and adjust this voltage frequency using an operating section of the controller 15.

During the above operation, the particles 30 in the liquid undergo the dielectrophoretic force so as to be concentrated while heading for the particle concentrated liquid outflow channel 24. For this reason, only the liquid is drawn into the particle-free liquid outflow channel 23, where the particles 30 are then separated from the liquid.

The particles 30 in the liquid, therefore, are guided in a definite direction to move between a plurality of micropillars 26 while undergoing the dielectrophoretic force, and separated from the liquid. Hence, the particle separation device and method contemplated so as to require no membrane cleaning, and yet so as to cause no clogging, extend device life, reduce a pressure loss, and enable increasing throughput capacity and downsizing the device, can be provided.

FIGS. 6 to 8 are diagrams that show examples of a shape and layout of electrodes in a microflow channel of the particle separation device in the embodiment of the present invention.

FIG. 6 shows an example in which an electrode 2501 is disposed at an upstream side of a micropillar group 2601 and an electrode 2501 at a downstream side of the micropillar group 2601. In this case, the electrodes 2501, 2502 are formed as thin-film electrodes at a lower surface of the flow channel.

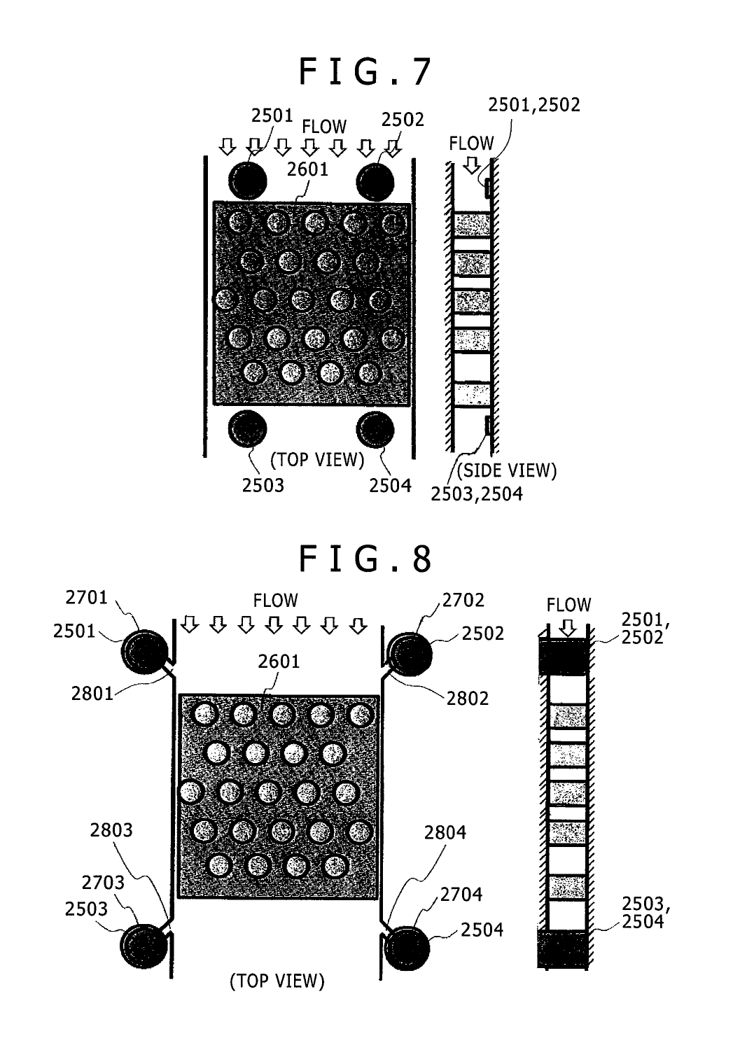

FIG. 7 shows an example in which electrodes 2501 to 2504 are formed into a circular shape and the electrodes 2501, 2502 are disposed at an upstream side of a micropillar group 2601 and the electrodes 2503, 2504 at a downstream side of the micropillar group 2601. In this case, the electrodes 2501, 2502, 2503, 2504 are formed as thin-film electrodes at a lower surface of the flow channel.

FIG. 8 shows an example in which electrodes 2501 to 2504 are formed into a circular shape and the electrodes 2501, 2502 are disposed in electrode inserting portions 2701 and 2702 across the flow channel, at an upstream side of a micropillar group 2601, and the electrodes 2503, 2504 are disposed in electrode inserting portions 2703 and 2704 across the flow channel, at a downstream side of the micropillar group 2601.

In this case, the electrodes 2501-2504 are inserted in the flow channel through holes formed in the covering substrate 2. Additionally the electrode inserting portions 2701, 2702, 2703, 2704 are connected to the flow channel via connection paths 2801, 2802, 2803, 2804, respectively.

FIGS. 9 to 14 are diagrams that show examples of a shape of micropillars of the particle separation device in the embodiment of the present invention.

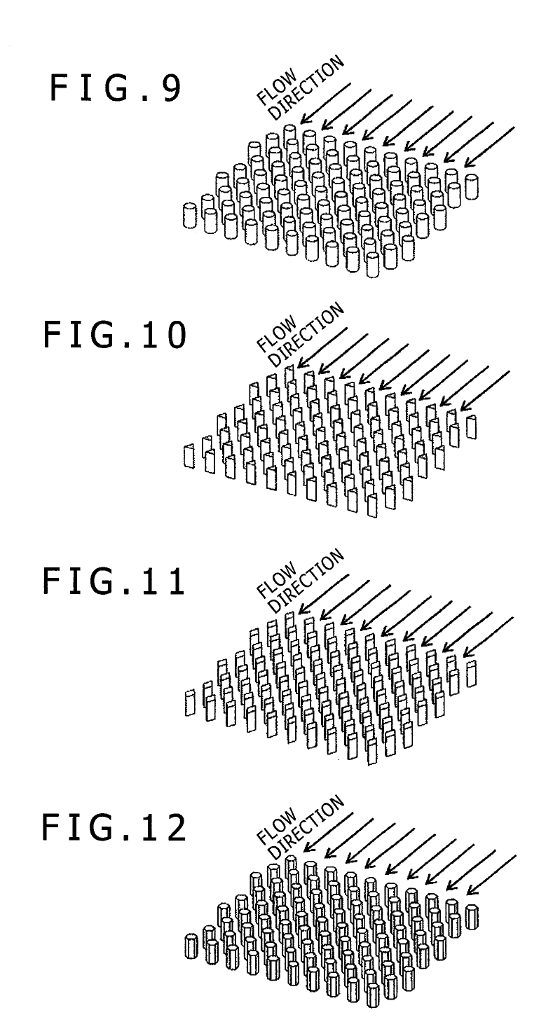

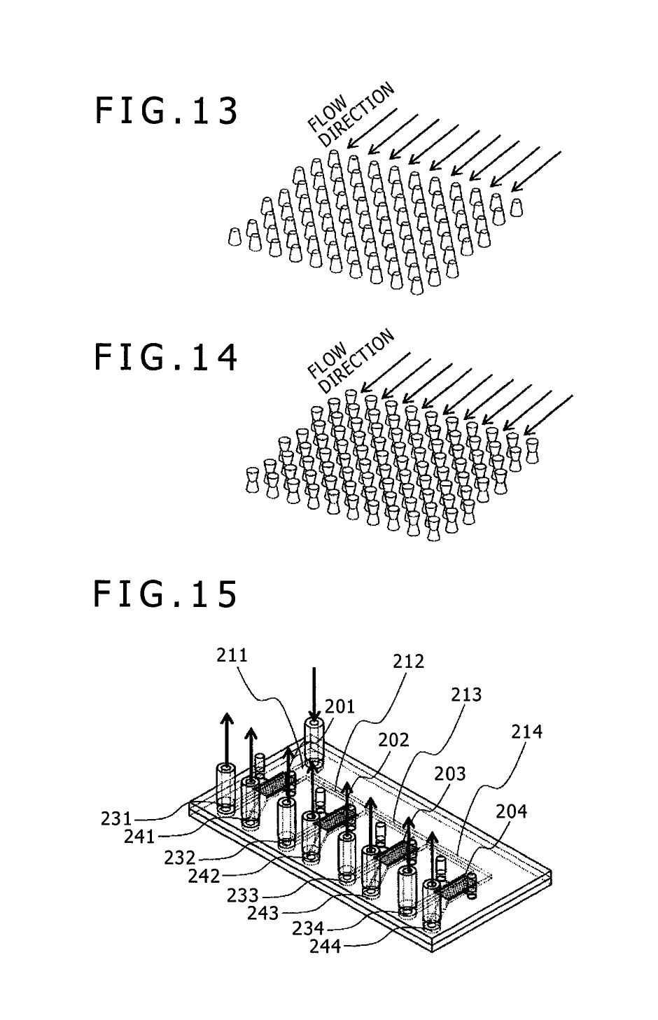

FIG. 9 is a diagram that shows micropillars circular in section. FIG. 10 is a diagram that shows micropillars triangular in section. FIG. 11 is a diagram that shows micropillars rhombic in section. FIG. 12 is a diagram that shows micropillars hexagonal in section. FIG. 13 is a diagram that shows micropillars circular in section and uniformly sloped in their height direction. While the example in FIG. 13 shows a case in which an area of an upper surface of each micropillar is smaller than that of a lower surface of the micropillar, the area of the upper surface of the micropillar may be larger than that of the lower surface. FIG. 14 is a diagram that shows micropillars circular in section and sloped in their height direction, each of the micropillars being the smallest in section at an intermediate portion between an upper surface and lower surface of the micropillar.

Any one of the micropillar shapes shown in FIGS. 9-14 may be applied to the present invention.

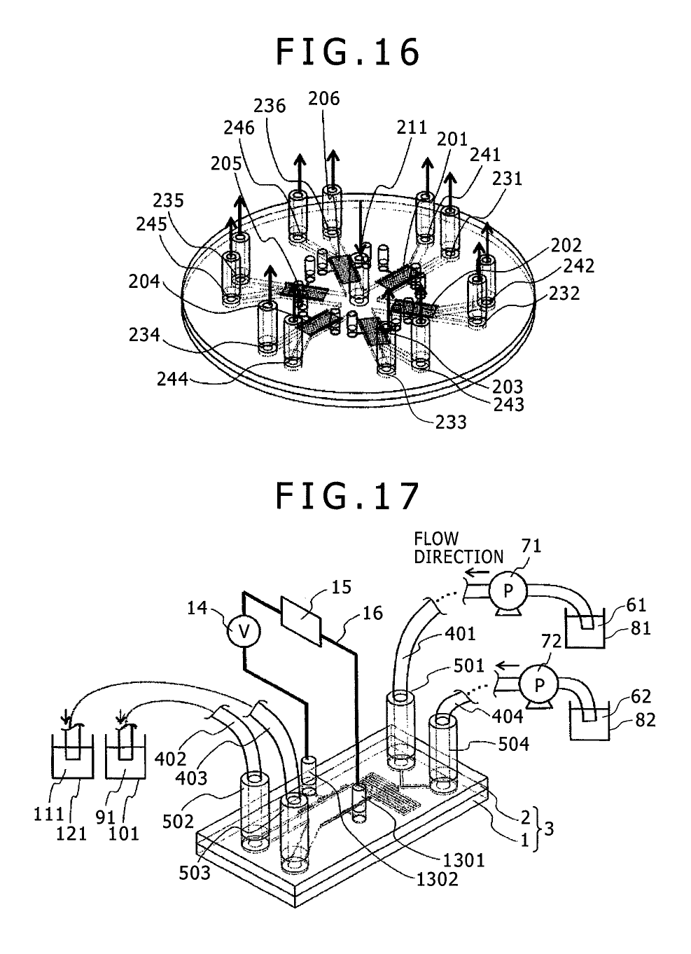

FIGS. 15 and 16 are diagrams that show examples in which the particle separation device in the embodiment of the present invention is constructed for treating a large amount of liquid.

The example in FIG. 15 shows a plurality of particle separation units, 201, 202, 203, and 204, that are connected to each other rectilinearly in parallel. The particle separation units 201, 202, 203, 204 are each of the same configuration as that of the particle separation device shown in FIG. 1.

Referring to FIG. 15, a particle suspension flows into each of the particle separation units 201, 202, 203, 204 from a common particle suspension inflow channel 211 through intermediate inflow channels 212, 213, and 214. A particle-free liquid in each particle separation unit 201, 202, 203, 204 flows out through one of particle-free liquid outflow channels 231, 232, 233, and 234.

In addition, a particle concentrated liquid in the particle separation unit 201, 202, 203, 204 flows out through one of particle concentrated liquid outflow channels 241, 242, 243, and 244.

FIG. 16 shows an example in which a plurality of particle separation units, 201, 202, 203, 204, 205, and 206, are arranged circularly and connected to each other in parallel.

Referring to FIG. 16, a particle suspension flows into each of the particle separation units 201, 202, 203, 204, 205, 206 through a particle suspension inflow channel 211 common to the particle separation units 201, 202, 203, 204, 205, 206. The particle suspension inflow channel 211 is formed in a central portion of the circularly arranged separation units 201, 202, 203, 204, 205, 206.

A particle-free liquid in each of the particle separation units 201, 202, 203, 204, 205, 206 flows out through one of particle-free liquid outflow channels 231, 232, 234, 235, and 236 disposed at an outer peripheral side of each particle separation unit 201, 202, 203, 204, 205, 206 circularly disposed.

A particle concentrated liquid in each of the particle separation units 201, 202, 203, 204, 205, 206 flows out through one of particle concentrated liquid outflow channels 241, 242, 243, 244, 245, and 246 disposed at the outer peripheral side of each particle separation unit 201, 202, 203, 204, 205, 206 circularly disposed.

With the configuration shown in FIG. 15 or 16, particles can be separated at a high rate from a large amount of liquid. For example, particles can be separated from a large amount of sludge rapidly.

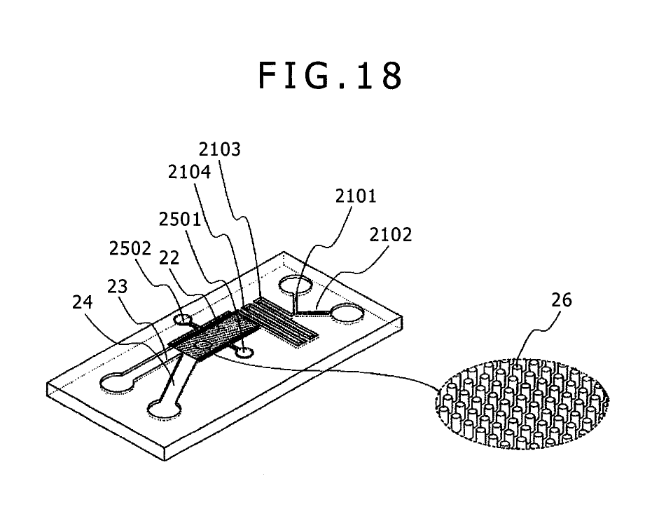

FIGS. 17 and 18 are diagrams that show examples of application to a boron removal device which uses the particle separation device according to the embodiment of the present invention.

FIG. 17 is an overall schematic block diagram of the boron removal device in the embodiment of the present invention. The boron removal device in FIG. 17 includes the following: a flow channel device 3 with a flow channel substrate 1 and a covering substrate 2; line connectors 501, 502, 503, and 504 that connect the flow channel device 3 and lines 401, 402, 403, and 404; a pump 71 that supplies a boron-containing, untreated liquid 61 to the flow channel device 3; an untreated liquid container 81 accommodating the untreated liquid 61; a pump 72 that supplies a boron-adsorbing particle suspension 62; and a boron-adsorbing particle suspension container 82 accommodating the boron-adsorbing particle suspension 62.

The boron removal device further includes the following: a boron-free liquid container 101 accommodating a boron-free liquid 91 that flows out from the flow channel device 3; a boron concentrated liquid container 121 accommodating a boron concentrated liquid 111 that flows out from the flow channel device 3; electrode connectors 1301 and 1302 that electrically connect to electrodes disposed inside the flow channel device 3; a power supply 14 that supplies a voltage to be applied to the electrodes; a controller 15 that controls the voltage to be applied to the electrodes; and an electrical line 16 that electrically connects the electrode connectors 1301, 1302, the power supply 14, and the controller 15, to each other.

FIG. 18 is a diagram that shows construction of a boron removal unit formed on the flow channel substrate 1 of the boron removal device shown in FIG. 17. Referring to FIG. 18, the boron removal unit includes: an untreated-liquid inflow channel 2101; a boron-adsorbing particle suspension inflow channel 2102; a mixing section 2103 at which the untreated liquid and the boron-adsorbing particle suspension are mixed; an adsorbing section 2104 at which boron becomes adsorbed onto boron-adsorbing particles; a particle separating section 22 that separates the boron-adsorbing particles from the liquid; a boron-free liquid outflow channel 23; a boron concentrated liquid outflow channel 24; and the electrodes 2501, 2502. A plurality of micropillars 26 having substantially the same construction as that shown in FIG. 3 are formed on the particle separating section 22.

The untreated liquid 61 that flows in through the boron-adsorbing particle suspension inflow channel 2102, and the boron-adsorbing particle suspension 62 that flows in through the boron-adsorbing particle suspension inflow channel 2102 are mixed at the mixing section 2103.

After the above mixing, at the adsorbing section 2104 located at a downstream side of the mixing section 2103, the boron contained in the liquid becomes adsorbed onto a plurality of boron-adsorbing particles. After this, at the separating section 22 located downstream of the adsorbing section 2104, the particles onto which the boron has been adsorbed are separated from the liquid by substantially the same operation as that of the particle separation device described above.

As a result, the boron contained in the untreated liquid 61 is drained with the boron-adsorbing particles, from the boron concentrated liquid outflow channel 24 located downstream of the particle separating section 22, and exits the flow channel. In addition, a liquid not containing boron is drained from the boron-free liquid outflow channel 23.

With the boron removal device shown in FIGS. 17 and 18 as part of the embodiment of the present invention, no cleaning is needed and yet, no membrane clogging, long device life, reduction in pressure loss, an increase in throughput, and miniaturization can be provided.

In the above-described example of the present invention, as shown in FIG. 5, the voltage is applied to the electrodes 2501 and 2502 during the particle capture time intervals (marked with circles 2, 4, 6) and the voltage is not applied during the particle movement time intervals (marked with circles 1, 3, 5, 7). The device, however, may be configured so that particles can be separated in a definite direction by the flow of the liquid without providing the particle movement time intervals.

### DESCRIPTION OF REFERENCE NUMBERS

1: Flow channel substrate
2: Covering substrate
3: Flow channel device
6: Particle suspension
7: Pump
9: Particle-free liquid
10: Particle-free liquid container
11: Particle concentrated liquid
12: Particle concentrated liquid container
14: Power supply
15: Controller
16: Electrical line
20: Particle separation unit
21: Particle suspension inflow channel
22: Particle separating section
23: Particle-free liquid outflow channel
24: Particle concentrated liquid outflow channel
26: Micropillar
1301, 1302: Electrode connectors
2501, 2502: Electrodes
401, 402, 403: Lines
501, 502, 503: Line connectors

1. A particle separation device, comprising:
a particle inflow section that draws in a suspension containing a plurality of dielectric particles suspended therein;
a particle separating section including
a flow channel to which the particle suspension is supplied from the particle inflow section and into which the particle suspension flows,
a plurality of micropillars each formed from an electrical insulating material and disposed in the flow channel, and
a voltage source that generates an electric field in the flow channel having the micropillars disposed therein, the plurality of micropillars being placed in such a position that the micropillars form electrically sparse and dense regions of the electric field generated by the voltage source to deflect the particles in a definite direction in the suspension;
a particle concentrated liquid outflow channel that draws out a particle concentrated liquid containing concentrated particles separated by the particle separating section; and
a particle-free liquid outflow channel that draws out a particle-free liquid from which the particles have been removed by the particle separating section.

2. The particle separation device according to claim 1, wherein
the plurality of micropillars form a plurality of rows disposed at fixed spatial intervals in a direction orthogonal to that in which the particle suspension flows, and
micropillars adjacent to each other with respect to the direction in which the particle suspension flows are disposed in positions shifted from each other by intervals narrower than the fixed spatial intervals, in the direction orthogonal to that in which the particle suspension flows.

3. The particle separation device according to claim 1, wherein
the voltage source intermittently applies voltage to the flow channel.

4. The particle separation device according to claim 1, wherein
the voltage source includes electrodes opposed to each other, on a lateral face forming the flow channel of the particle separating section.

5. The particle separation device according to claim 1, wherein
the voltage source includes electrodes disposed at an upstream side and downstream side of the flow channel of the particle separating section, the particle suspension flowing in the flow channel, the electrodes being opposed to each other.

6. The particle separation device according to claim 1, wherein
the micropillars have circular-shaped sections.

7. The particle separation device according to claim 1, wherein
the micropillars have triangular-shaped sections.

8. The particle separation device according to claim 1, wherein
the micropillars have square-shaped sections.

9. The particle separation device according to claim 1, wherein
the micropillars have hexagonal-shaped sections.

10. The particle separation device according to claim 1, wherein
the particle separating section, the particle concentrated liquid outflow channel, and the particle-free liquid outflow channel are each formed in plurality, which are connected to a common particle inflow channel.

11. A particle separation device, comprising:
a boron solution inflow section that draws in a boron solution which contains boron;
a boron-adsorbing particle suspension inflow section that draws in a suspension containing a plurality of boron-adsorbing particles suspended therein;
a mixing section positioned at a downstream side of the boron solution inflow section and the boron-adsorbing particle suspension inflow section, the mixing section mixing the boron solution and the boron-adsorbing particle suspension;
an adsorbing section positioned at a downstream side of the mixing section, the adsorbing section causing the boron in the boron solution to become adsorbed onto boron-adsorbing particles;
a particle separating section including
a flow channel to which the particle suspension containing the boron-adsorbing particles which have adsorbed the boron is supplied from the adsorbing section and into which the particle suspension flows,
a plurality of micropillars each formed from an electrical insulating material and disposed in the flow channel, and
a voltage source that generates an electric field in the flow channel having the micropillars disposed therein, the plurality of micropillars being placed in such a position that the micropillars form electrically sparse and dense regions of the electric field generated by the voltage source to deflect the particles in a definite direction in the suspension;
a particle concentrated liquid outflow channel that draws out a particle concentrated liquid containing concentrated particles separated by the particle separating section; and
a particle-free liquid outflow channel that draws out a particle-free liquid from which the particles have been removed by the particle separating section.

12. The particle separation device according to claim 11, wherein
the plurality of micropillars form a plurality of rows disposed at fixed spatial intervals in a direction orthogonal to that in which the particle suspension flows, and
micropillars adjacent to each other with respect to the direction in which the particle suspension flows are disposed in positions shifted from each other by intervals narrower than the fixed spatial intervals, in the direction orthogonal to that in which the particle suspension flows.

13. A particle separation method, comprising:
drawing in a suspension that contains a plurality of dielectric particles suspended therein;
passing the suspension through between a plurality of micropillars each formed from an electrical insulating material and disposed in the flow channel to which the particle suspension that has been drawn in is supplied and into which the particle suspension flows;
generating an electric field in the flow channel with the micropillars disposed therein;
causing the micropillars to form electrically sparse and dense regions of the electric field and thus to deflect the particles in a definite direction in the suspension and separate the particles from the suspension;
drawing out a particle concentrated liquid containing the concentrated particles that have been separated from the suspension, into a particle concentrated liquid outflow channel; and
drawing out a particle-free liquid, in which the particles have been removed from the suspension, into a particle-free liquid outflow channel.

14. The particle separation method according to claim 13, wherein
the plurality of micropillars form a plurality of rows disposed at fixed spatial intervals in a direction orthogonal to that in which the particle suspension flows, and
micropillars adjacent to each other with respect to the direction in which the particle suspension flows are disposed in positions shifted from each other by intervals narrower than the fixed spatial intervals, in the direction orthogonal to that in which the particle suspension flows.

15. The particle separation method according to claim 13, further comprising:
applying a voltage to the flow channel intermittently.
